(19) United States
(12) Patent Application Publication
(10) Pub. No.: US 2007/0162627 A1
(43) Pub. Date: Jul. 12, 2007

(54) Method and apparatus for diagnosing operating system resources supporting USB device driver development in Linux system

(76) Inventors: Jeong Si Kim, Daejeon (KR); Chae Deok Lim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/607,501

(22) Filed: Dec. 1, 2006

(30) Foreign Application Priority Data
Dec. 5, 2005 (KR) 10-2005-0117626
Jun. 22, 2006 (KR) 10-2006-0056190

(51) Int. Cl. G06F 3/00

(52) U.S. Cl. 710/8

(57) ABSTRACT

Provided are an apparatus and method for diagnosing operating system resources supporting universal serial bus (USB) device driver development for a Linux system. The apparatus and method device enable driver developers to simply perform, without professional knowledge of hardware and operating systems, operating system resource diagnosis such as detection and extraction of hardware information required for device driver development, search and change of various descriptor configurations, and process of data input/output through an endpoint. Thus, effort and cost required for a device driver development process are reduced, and it is possible to improve the efficiency of Linux USB device driver development work.

### CROSS-REFERENCE TO RELATED APPLICATION

This application claims priority to and the benefit of Korean Patent Application Nos. 2005-117626, filed Dec. 5, 2005, and 2006-56190, filed Jun. 22, 2006, the disclosures of which are incorporated herein by reference in their entirety.

### BACKGROUND

1. Field of the Invention

The present invention relates to an apparatus and method for diagnosing operating system resources supporting universal serial bus (USB) device driver development on a Linux system, and more particularly, to an apparatus and method for diagnosing operating system resources enabling a device driver developer to diagnose operating system resources, such as detection of hardware information required for device driver development, resource check, etc., without programming a kernel on a Linux system.

2. Discussion of Related Art

Device drivers for controlling devices in computer systems are important system software linking operating systems with hardware. With the appearance of various complex peripherals, high-speed and accurate device driver development has become very important for improving computer system performance and ensuring marketability.

However, device driver development is a very complex and difficult process requiring professional knowledge of a hardware system and an operating system. Thus, device driver development is dependent on a small number of experienced professional developers.

In addition, since hardware characteristics and methods by which an operating system processes a device differ greatly depending on the kind of device, one device driver developer cannot handle various kinds of devices.

In order to solve this problem, a few device driver development tools capable of reducing difficulty in device driver development have been developed. However, such device driver development tools have very limited functions, such as a simple search function and an input/output function for operating system resources allocated to a device on the basis of Windows and Linux operating systems. In addition, device driver development tools are designed to operate in a user space execution environment with limited access to operating system resource space, which sometimes causes them to operate unstably.

Furthermore, since a few currently used device driver development supporting tools provide simple individual functions only, it is necessary to combine or process the individual functions in order to utilize them for device driver development. However, the combination and process operations are very complex, and thus a device driver developer should manually program a kernel when it is necessary to extract precise device hardware information or control complex kernel resource information.

### SUMMARY OF THE INVENTION

The present invention is directed to an apparatus and method for diagnosing operating system resources, in universal serial bus (USB) device driver development for a Linux system, enabling device driver developers to diagnose operating system resources required for device driver development without professional knowledge of hardware and operating systems by automating a process requiring complex kernel programming based on a low-level code utilizing professional knowledge of hardware and operating systems.

One aspect of the present invention provides a method for diagnosing operating system resources supporting USB device driver development on a Linux system, comprising the steps of: (a) initializing an execution environment and then initializing a USB device selected as a diagnosis object; (b) collecting and storing hardware configuration information and descriptor information on the diagnosis object USB device; (c) setting up a device interface for the diagnosis object USB device; and (d) when an endpoint type for the diagnosis object USB device is selected, transmitting and receiving data through the selected endpoint.

Another aspect of the present invention provides an apparatus for diagnosing operation system resources supporting USB device driver development on a Linux system, comprising: an interface unit for serving as an interface with a user; an execution environment initialization unit for initializing an execution environment of the system; a device initialization process unit for making an operating system recognize a diagnosis object USB device; a device descriptor information management unit for collecting, storing and managing hardware configuration information and descriptor information on the diagnosis object USB device; an endpoint input/output process unit for performing endpoint input/output diagnosis on the diagnosis object USB device; and a device connection disconnect unit for disconnecting connection with the diagnosis object USB device.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of an apparatus for diagnosing operating system resources supporting universal serial bus (USB) device driver development according to an exemplary embodiment of the present invention; and

FIG. 2 is a flowchart showing a method for diagnosing operating system resources supporting USB device driver development according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the exemplary embodiments disclosed below and can be implemented in various forms. Therefore, the present exemplary embodiments are provided for complete disclosure of the present invention and to fully convey the scope of the present invention to those of ordinary skill in the art.

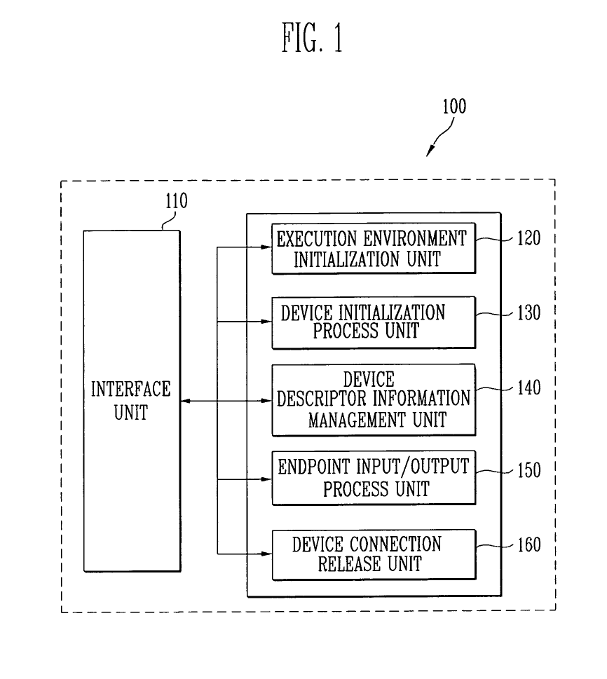

FIG. 1 is a block diagram of an apparatus for diagnosing operating system resources supporting universal serial bus (USB) device driver development according to an exemplary embodiment of the present invention.

As illustrated in FIG. 1, the apparatus 100 for diagnosing operating system resources supporting USB device driver development comprises an interface unit 110 for serving as an interface between the apparatus and a user, an execution environment initialization unit 120 for initializing a system environment required to run the apparatus, a device initialization process unit 130 for making an operating system recognize a diagnosis object USB device, a device descriptor information management unit 140 for managing characteristics and configuration information of the USB device, an endpoint input/output process unit 150 for performing endpoint input/output diagnosis on the diagnosis object USB device, and a device connection disconnect unit 160 for disconnecting connection with the diagnosis object USB device.

The interface unit 110 makes a menu with the list of operating system diagnosis functions that can be provided, provides the user with the menu, and performs selection of a function needed by the user and call processing according to the selected function.

The execution environment initialization unit 120 checks the existence and location information of a USB device file system for providing basic hardware information of USB devices coupled to a USB bus in a Linux system.

In addition, the execution environment initialization unit 120 initializes an execution environment of the apparatus in order to diagnose operating system resources allocated to the USB devices.

The device initialization process unit 130 is intended to perform initialization of the USB device selected as a diagnosis object. The device initialization process unit 130 registers the diagnosis object USB device in the operating system of the Linux system so as to have access to the USB device selected as a diagnosis object, and calculates the size of device descriptor information on the selected USB device provided by the Linux operating system.

After ensuring a storage space in a user space on the basis of the device descriptor information size calculated by the device initialization process unit 130, the device descriptor information management unit 140 extracts device descriptor information from a kernel space, stores the extracted device descriptor information in the ensured storage space, and manages it.

Preferably, the device descriptor information may be stored to be easily searched.

Here, the device descriptor information includes all descriptors on a device, a configuration, an interface, and an endpoint, which are configuration information components standardized for a USB device.

In other words, USB, which is an interface method, provides configuration information about various devices so that the device descriptor information management unit 140 can select a configuration appropriate to a function to be provided by a corresponding device. Here, the device descriptor is intended to provide configuration information about various devices.

The endpoint input/output process unit 150 processes an input/output diagnosis function for an endpoint, which is a data transmission passage of a USB device. The input/output diagnosis function for an endpoint is described in detail below.

USB uses a token-based bus architecture. A USB host broadcasts tokens on a bus, and a USB device matched with an address included in the token transmits data to the host or receives data from the host.

For such operations, the USB device can provide a plurality of channels used for communication with the host, and the channels can be considered as pipes. The pipes respectively connect endpoints in the device to the host, and the device receives data from the host through the endpoints, writes the data in the endpoints, and transmits the data to the host. In other words, each pipe enables bidirectional data transmission.

In such a USB device, one endpoint has one of four transmission types: control transmission, bulk transmission, interrupt transmission and isochronous transmission, according to characteristics of transmission data. Characteristics of the endpoint types are described below.

(1) control transmission: for transmitting a small amount of data, used to configure a USB device, and has at least the minimum control commands.

(2) bulk transmission: used to transmit a large amount of data in packet format without error regardless of a transmission time.

(3) interrupt transmission: used to transmit a relatively small amount of data at fixed time intervals.

(4) isochronous transmission: used to transmit a fixed amount of data at a fixed speed, does not ensure reliable transmission, and generally useful in transmitting audio or video data.

In order to perform an input/output process suited to an endpoint type, in the case of a control transmission endpoint, the endpoint input/output process unit 150 generates a setup packet and then transmits data suited to a process method of the setup packet or receives a method requested by the setup packet.

In addition, in the case of a bulk transmission, interrupt transmission or isochronous transmission endpoint, the endpoint input/output process unit 150 directly transmits or reads data to/from the corresponding pipe address.

Preferably, a result value received from an isochronous transmission endpoint may be processed into multimedia data, which can be directly checked by the user, and output.

Before finishing diagnosis of operating system resources for the diagnosis object USB device, the device connection disconnect unit 160 cancels the registration of the corresponding device in the operating system and returns the corresponding operating system resources, thereby disconnecting the connection with the diagnosis object USB device on the Linux system.

As described above, the apparatus for diagnosing operating system resources according to the present invention automates processes, such as extraction of device hardware information required for device driver development, configuration and management of device descriptors, set-up of endpoints, requiring professional knowledge of hardware and operating systems in USB device driver development for a Linux system, thereby enabling device driver developers to diagnose operating system resources required for device driver development without professional knowledge of hardware and operating systems.

A method for diagnosing operating system resources supporting USB device driver development will be described in detail below with reference to the appended drawings.

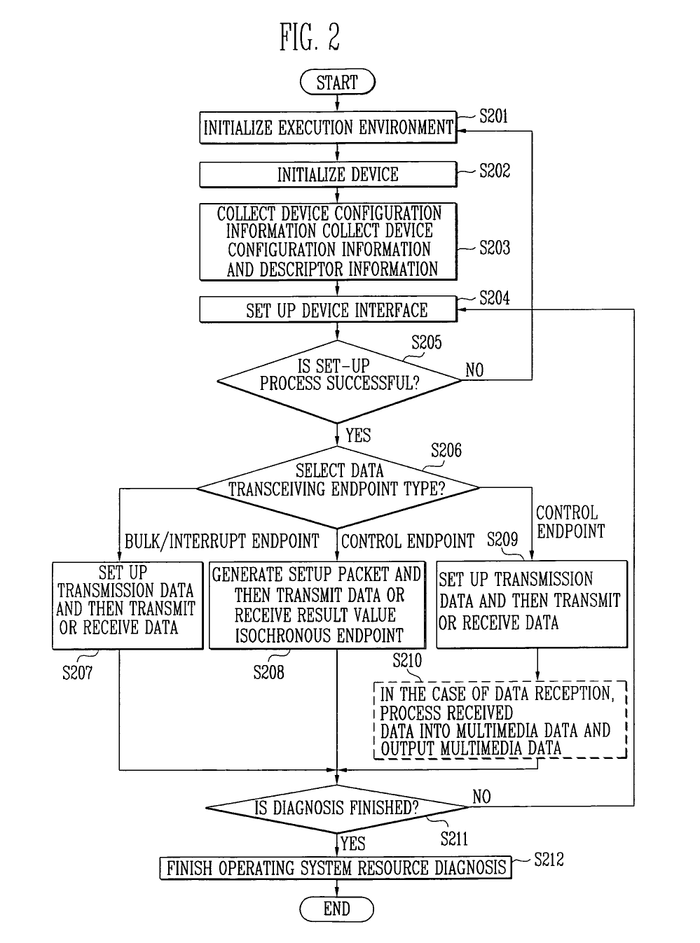

FIG. 2 is a flowchart showing a method for diagnosing operating system resources supporting USB device driver development according to an exemplary embodiment of the present invention.

For convenience, it is assumed that diagnosis of operating system resources allocated to USB devices is performed in a state in which the USB devices are coupled to a USB bus.

First, in step 201, an execution environment is initialized for diagnosis of operating system resources allocated to the USB devices.

Preferably, the execution environment initialization step (step 201) may include the step of checking whether or not a USB device file system for providing basic hardware information of the USB devices exists, and checking location information of the USB device file system.

In step 202, a USB device selected as a diagnosis object is initialized.

Preferably, at the same time, the USB device selected as a diagnosis object may be registered in the operating system of a Linux system so as to have access to the diagnosis object USB device, and the size of device descriptor information on the USB device provided by the Linux operating system may be calculated.

When the initialization of the diagnosis object USB device is finished through the above-described process, configuration information and descriptor information about the diagnosis object USB device is collected and stored in step 203, which is described in more detail below.

First, a device descriptor information storage space is ensured in a user space on the basis of the device descriptor information size calculated in the device initialization step (step 202). Then, the configuration information and descriptor information on the diagnosis object USB device is collected from a kernel space and organized to be easily searched and stored in the ensured user space.

Subsequently, a device interface that can be processed by one device driver is set for the diagnosis object USB device in step 204, and then it is determined whether or not the device interface set-up process is successful in step 205.

When an error is generated in the device interface set-up process, the method goes back to the execution environment initialization step (step 201).

Meanwhile, when the device interface set-up process is successful, the type of an endpoint that will be a passage for data transmission/reception is selected according to characteristics of data to be transmitted/received, in step 206.

When an endpoint of the bulk transmission or interrupt transmission type is selected in the endpoint type selection step (step 206), transmission data is set up, an access method available for the endpoint is checked, and the set-up data is transmitted to a host device (not shown in the drawings) or data is received from the host device, in step 207.

When a control transmission-type endpoint is selected in the endpoint type selection step (step 206), a setup packet is generated, and then a transmission/reception process with the host device (not shown in the drawings) is performed according to the transmission type set in the setup packet, in step 208.

When an isochronous transmission-type endpoint is selected in the endpoint type selection step (step 206), an access method of the endpoint is checked in step 209. Subsequently, when data is received from the host device (not shown in the drawings), the received data is processed into multimedia data, which can be directly checked by a user, and output, in step 210.

In step 211, it is checked whether or not the diagnosis of operating system resources will be finished. When successive operating system diagnosis is desired, a new device interface is selected, so that various diagnoses can be continuously made.

Meanwhile, when a diagnosis finish request is received from the user in the step checking whether diagnosis of operating system resources will be finished (step 211), diagnosis of operating system resources for the diagnosis object USB device is finished, in step 212.

Here, before finishing the diagnosis on the diagnosis object USB device, it is preferable to cancel the registration of the device in the operating system, return the corresponding operating system resources, and thereby disconnect connection between the Linux system and the diagnosis object USB device.

As described above, according to the method for diagnosing operating system resources, device driver developers can simply perform, without professional knowledge of hardware and operating systems, detection and extraction of hardware information required for device driver development, searching and changing of various descriptors' configurations, and processing of data input/output through an endpoint, thereby reducing effort and cost required for a device driver development process. Thus, it is possible to improve the efficiency of Linux USB device driver development work.

Meanwhile, the above-described exemplary embodiments can be written as a computer program, stored on a computer-readable medium, and executed in a general-purpose computer.

As described above, according to the present invention, a complex and time-consuming process required for embodying a low-level process function such as device hardware information extraction or kernel resource information management is automated, so that device driver developers can easily and quickly diagnose operating system resources required for USB device driver development without professional knowledge of hardware and operating systems. Therefore, it is possible to efficiently reduce time and human resources required for device driver development, in which a lot of manual operations by a developer are needed, on a Linux system having insufficient software development tools and utilities.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for diagnosing operating system resources supporting universal serial bus (USB) device driver development on a Linux system, comprising the steps of:
(a) initializing an execution environment and then initializing a USB device selected as a diagnosis object;
(b) collecting and storing hardware configuration information and descriptor information on the diagnosis object USB device;
(c) setting up a device interface for the diagnosis object USB device; and
(d) when an endpoint type for the diagnosis object USB device is selected, transmitting and receiving data through the selected endpoint.

2. The method of claim 1, wherein step (a) comprises:
a first step of checking the existence and location information of a file system for the diagnosis object USB device during the execution environment initialization;
a second step of registering the diagnosis object USB device in an operating system of the Linux system; and
a third step of calculating a size of the device descriptor information of the diagnosis object USB device.

3. The method of claim 2, wherein step (b) comprises the steps of:
ensuring an information storage space in a user space on the basis of the device descriptor information size calculated in the third step;
collecting the hardware configuration information and the device descriptor information on the diagnosis object USB device from a kernel space; and
organizing the collected information to be easily searched and storing the collected information in the ensured user space.

4. The method of claim 1, wherein in step (d), when a bulk transmission or interrupt transmission-type endpoint is selected, transmission data is set up, an access method available for the endpoint is checked, and the set-up data is transmitted to/received from a host device.

5. The method of claim 1, wherein in step (d), when a control transmission-type endpoint is selected, a setup packet is generated and transmitted to/received from a host device according to a transmission type set in the setup packet.

6. The method of claim 1, wherein in step (d), when an isochronous transmission-type endpoint is selected, the data is transmitted to/received from a host device according to an access method of the selected isochronous transmission-type endpoint, and the data received from the host device is processed into multimedia data and then output.

7. The method of claim 1, when operating system resource diagnosis is requested to be finished, further comprising the steps of:
canceling registration of the diagnosis object USB device in an operating system and returning operating system resources associated with the diagnosis object USB device; and
disconnecting connection with the diagnosis object USB device.

8. An apparatus for diagnosing operating system resources supporting USB driver development on a Linux system, comprising:
an interface unit for serving as an interface with a user;
an execution environment initialization unit for initializing an execution environment of the system;
a device initialization process unit for making an operating system recognize a diagnosis object USB device;
a device descriptor information management unit for collecting, storing and managing hardware configuration information and descriptor information on the diagnosis object USB device;
an endpoint input/output process unit for performing endpoint input/output diagnosis on the diagnosis object USB device; and
a device connection disconnect unit for disconnecting connection with the diagnosis object USB device.

9. The apparatus of claim 8, wherein the interface unit makes a menu with a list of operating system diagnosis functions that can be provided, provides the user with the menu, and performs call processing according to an operating system resource diagnosis function selected by the user.

10. The apparatus of claim 8, wherein the execution environment initialization unit checks the existence and location information of a file system for the diagnosis object USB device during the execution environment initialization.

11. The apparatus of claim 8, wherein the device initialization process unit registers the diagnosis object USB device in the operating system of the Linux system and calculates a device descriptor information size of the diagnosis object USB device.

12. The apparatus of claim 8, wherein the device descriptor information management unit ensures an information storage space in a user space on the basis of a device descriptor information size calculated by the device initialization process unit, collects the hardware configuration information and device descriptor information on the diagnosis object USB device from a kernel space, organizes the collected information to be easily searched, and stores the collected information in the ensured user space.

13. The apparatus of claim 8, wherein the device descriptor information comprises at least one of device descriptor information, configuration descriptor information, interface descriptor information, and endpoint descriptor information.

14. The apparatus of claim 8, wherein the endpoint input/output process unit, when an endpoint for the diagnosis object USB device is a bulk or interrupt transmission type, sets up transmission data, checks an access method available for the endpoint, and transmits/receives the set-up data to/from a host device,
when the endpoint for the diagnosis object USB device is a control transmission type, generates a setup packet and transmits/receives the setup packet to/from the host device according to the transmission type set in the setup packet, and
when the endpoint for the diagnosis object USB device is an isochronous transmission type, transmits/receives data to/from the host device according to an access method of the isochronous transmission-type endpoint.

15. The apparatus of claim 14, wherein the endpoint input/output process unit processes data received from the isochronous transmission-type endpoint into multimedia data and outputs the processed data.

16. The apparatus of claim 8, wherein the device connection disconnect unit cancels registration of the diagnosis object USB device in the operating system, returns operating system resources associated with the diagnosis object USB device, and disconnects the connection with the diagnosis object USB device.
